(19) United States
(12) Patent Application Publication
(10) Pub. No.: US 2021/0253794 A1
(43) Pub. Date: Aug. 19, 2021

(54) STAIN-RESISTANT BRANCHED POLYAMIDES

(71) Applicant: AdvanSix Resins & Chemicals LLC, Parsippany, NJ (US)

(72) Inventors: Veera Nelliappan, Richmond, VA (US); David J. Loy, Richmond, VA (US); Farzaneh Talebi, Midlothian, VA (US); Joseph Weston, Parsippany, NJ (US); Mary T. Strzelecki, Richmond, VA (US)

(21) Appl. No.: 17/177,182

(22) Filed: Feb. 16, 2021

Related U.S. Application Data
(60) Provisional application No. 62/978,465, filed on Feb. 19, 2020.

(51) Int. Cl. C08G 69/42; C08G 69/04; D01F 6/80

(52) U.S. Cl. CPC C08G 69/42; D01F 6/80; C08G 69/04

(57) ABSTRACT

The present disclosure provides a polyamide composition and method of making a polyamide composition. The polyamide composition includes branched chains to provide for greater fiber tenacity and residues of a salt of 5-sulfoisophthalic or 5-sulfoisophthalic acid to provide excellent stain resistance.

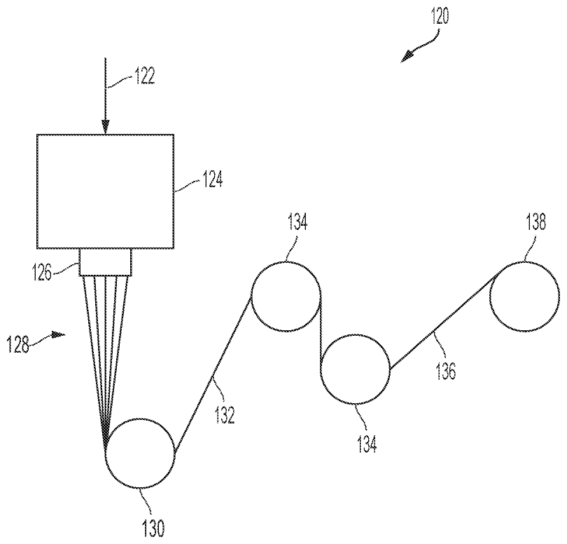

### CROSS-REFERENCE TO RELATED APPLICATION

This application claims priority to Provisional Application No. 62/978,465, filed Feb. 19, 2020, which is herein incorporated by reference in its entirety.

### FIELD

The present disclosure provides a branched polyamide with desirable processability and stain resistance.

### BACKGROUND

High molecular weight polyamides are desirable substrates for a wide variety of applications. However, synthesis of such polymers is complicated by the need to remove water from the composition, which may be energy- and labor-intensive. Furthermore, as molecular weight increases, viscosity increases. When polyamides are subjected to processing conditions, such as melt processing, further polymerization of the substrate may occur. As polymerization continues, viscosity increases, which may lead to damage of equipment and inconsistent processing behavior in applications such as high-speed spinning.

On the other hand, spinning, often at high speed, is commonly used to produce nylon fibers. Thus produced nylon fibers may become stained when a substance wets the fibers. Some stain resistant fibers are available; however, those currently in use suffer from difficulties in processability and/or achieving higher draw ratios for higher strength fibers. It will be desirable to have highly stain-resistant fibers that are easily processed using available manufacturing techniques.

### SUMMARY

The present disclosure provides a polyamide composition and method of making a polyamide composition according to the general formula:

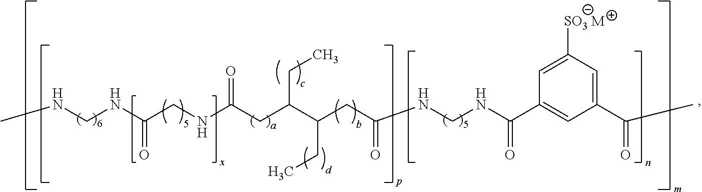

in which M is a lithium ion, a sodium ion, a potassium ion, or a hydrogen ion, a=6 to 10, b=6 to 10, c=4 to 10, d=4 to 10, n=1 to 20, p=1 to 1000, m=1 to 400 and x=4-200.

In one form thereof, the present disclosure provides a polyamide composition including the following formula:

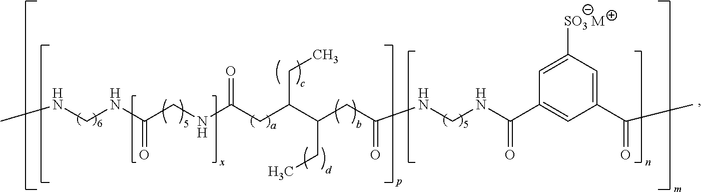

in which M is a lithium ion, a sodium ion, a potassium ion, or a hydrogen ion a=6 to 10, b=6 to 10, c=4 to 10, d=4 to 10, n=1 to 20, p=1 to 1000, m=1 to 400 and x=4-200.

The polyamide composition may include a residue of a salt of 5-sulfoisophthalic acid. The salt of 5-sulfoisophthalic acid may be selected from the group consisting of sodium 5-sulfoisophthalate, lithium 5-sulfoisophthalate and potassium 5-sulfoisophthalate. A concentration of the residue of the salt of 5-sulfoisophthalic acid may be from 0.1 wt. % to 15 wt. % based on a total weight of the polyamide composition.

The polyamide composition may include a residue of a dimer acid, the dimer acid including two carbon chains each having more than 5 carbons. A concentration of the residue of dimer acid may be from 6 wt. % to 18 wt. % based on a total weight of the polyamide composition. A total amine end group concentration of the polyamide composition may be from about 5 millimoles per kilogram to about 50 millimoles per kilogram.

A relative viscosity (RV) of the polyamide composition may be from about 2.0 to about 7.0 RV, as determined by GB/T 12006.1-2009/ISO 307:2007. A formic acid viscosity of the polyamide composition may be from about 200 FAV to about 950 FAV, as measured by ASTM D-789-07. A color difference ΔE may be less than 10, per CIE DE2000.

In another form thereof, the present disclosure provides a fiber formed from any of the polyamide compositions recited above, the fiber having a tenacity from 4.8 to 7.0 grams per denier. The fiber may have a tenacity of from 6.0 to 7.0 grams per denier.

In another form thereof, the present disclosure provides a method of making a polyamide composition having the formula:

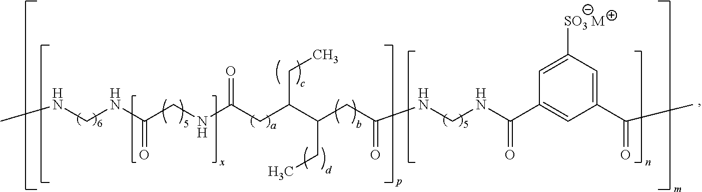

in which M is a lithium ion, a sodium ion, a potassium ion, or a hydrogen ion, a=6 to 10, b=6 to 10, c=4 to 10, d=4 to10, n=1 to 20, p=1 to 1000, m=1 to 400 and x=4-200. The method includes providing caprolactam, a dimer acid, a diamine and at least one of: a 5-sulfoisophthalic acid salt or 5-sulfoisophthalic acid to a reactor; mixing the caprolactam, the dimer acid, the diamine and the at least one of: 5-sulfoisophthalic acid salt and 5-sulfoisophthalic acid together in the reactor; and reacting the caprolactam, the dimer acid, the diamine and the at least one of: 5-sulfoisophthalic acid salt and 5-sulfoisophthalic acid within the reactor at a reaction temperature.

In the providing step, the at least one of: 5-sulfoisophthalic acid salt and 5-sulfoisophthalic acid may be from 0.1 wt. % to 15 wt. % based on a total weight of the polyamide composition. In the providing step, the at least one of: 5-sulfoisophthalic acid salt and 5-sulfoisophthalic acid may be a 5-sulfoisophthalic acid salt selected from the group consisting of: sodium 5-sulfoisophthalate, lithium 5-sulfoisophthalate and potassium 5-sulfoisophthalate. In the providing step, the diamine may include hexamethylenediamine. In the providing step, the dimer acid may be from 6 wt. % to 18 wt. % based on a total weight of the polyamide composition.

In the reacting step, the reactor may be pressurized for a portion of the reacting step. In the reacting step, the reactor may be under vacuum for a portion of the reacting step. In the reacting step, the reaction temperature may be from about 225° C. to about 290° C.

In another form thereof, the present disclosure provides for a method of making a fiber. The method includes extruding a polyamide composition made as described above and spinning the extruded polyamide composition at a take up speed of from about 200 meters per minute to about 2,000 meters per minute. The take up speed may be from about 400 meters per minute to about 1,600 meters per minute.

The above mentioned and other features of the invention, and the manner of attaining them, will become more apparent and the invention itself will be better understood by reference to the following description.

### BRIEF DESCRIPTION OF THE DRAWINGS

The FIGURE is an example of a system for extrusion, spinning, and drawing fibers or filaments.

### DETAILED DESCRIPTION

Polyamide compositions may be formed from precursors such as caprolactam via hydrolysis, polyaddition, and polycondensation reactions. When these materials are formed from caprolactam, the lactam ring is opened to form two end groups: one amine and one carboxylic acid or carboxylate. Polyaddition combines the lactam monomers into intermediate molecular weight oligomers, and polycondensation combines oligomers into higher molecular weight polymers.

The polycondensation produces water. Removal of the water drives the formation of higher molecular weight polymers. One method to remove water includes the application of increasing amounts of vacuum when higher molecular weight polymers are desired. However, application of increasingly high vacuum is not practical over extended periods of time as water becomes scarce within the mixture, and therefore more difficult to extract.

Polyamide compositions may also continue to increase in molecular weight over time as the amine and carboxylic acid or carboxylate end groups continue to react with each other. This molecular weight instability can increase the viscosity of the polyamide compositions, resulting in altered or inconsistent processing, such as in high-speed spinning applications, for example.

The present disclosure provides stain resistant, branched, polyamide compositions. The polyamide compositions include dimer acid residues. The dimer acid residues provide branching structures to the polyamide compositions. Branched polyamide compositions exhibit similar characteristics to higher molecular weight linear polymers. Additionally, the removal of water from branched polyamides is much easier than from high molecular weight polymers. Thus, the manufacture of branched polyamides can result in polyamide compositions with the desirable characteristics of high molecular weight polymers without the difficulties posed by residual water.

The polyamide composition further includes a residue of 5-sulfoisophthalic acid salt or 5-sulfoisophthalic acid. It has been found that by incorporating a 5-sulfoisophthalic acid or 5-sulfoisophthalic acid salt into branched polyamide compositions, highly stain-resistant fibers which can be easily processed from the polyamide compositions using available manufacturing techniques, are obtained. Typically, in nylon copolymers, dicarboxylic acids are stoichiometrically balanced with diamines. However, the dimer acid and the 5-sulfoisophthalic acid salt or 5-sulfoisophthalic acid can be used in excess to reduce the concentration of amine end groups. Without wishing to be bound by any theory, it is believed that the reduction in the concentration of amine end groups reduces the available locations to which food stains, which are primarily acidic in nature, may bind to the polyamide composition.

Reducing the concentration of the amine end groups also stabilizes the molecular weight of the polyamide composition because the carboxylic acid or carboxylate ends retard further polyaddition or polycondensation reactions in the absence of amine end groups with which to react. It has been found that polyamide compositions incorporating branching along with incorporating a 5-sulfoisophthalic acid salt or 5-sulfoisophthalic acid are more consistently and predictably processed into highly stain-resistant products, such as fibers.

The present disclosure provides a polyamide composition having the following formula:

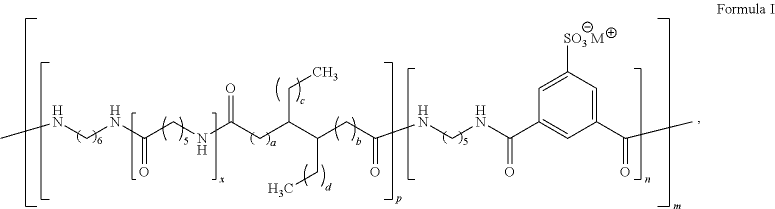

wherein M is a lithium ion, a sodium ion, a potassium ion, or a hydrogen ion; a=6 to 10; b=6 to 10; c=4 to 10; d=4 to 10; n=1 to 20; p=1 to 1000; m=1 to 400 and x=4 to 200. It is understood that the polyamide composition described by Formula I is a random copolymer.

The polyamide compositions provided by the present disclosure may be formed from caprolactam, one or more dimer acids, one or more diamines and a 5-sulfoisophthalic acid salt or 5-sulfoisophthalic acid. The resulting polyamide compositions include a residue of the caprolactam, a residue of the dimer acid, a residue of the diamine and a residue of the 5-sulfoisophthalic acid salt or 5-sulfoisophthalic acid.

The caprolactam (also called hexano-6-lactam, azepan-2-one, and ε-caprolactam) is shown below:

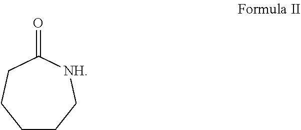

The dimer acid can be as shown below:

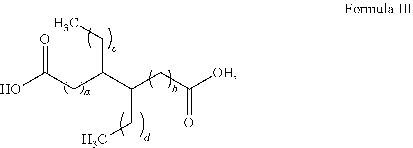

wherein a and b can each independently range from 6 to 10 and c and d can each independently range from 4 to 10. The dimer acid may be saturated, or may include one or more unsaturated bonds. Two carbon chains, identified by the carbon atom counts c and d in Formula III, branch off the main polymer chain, as shown in Formula I, thus making the polymer composition of Formula I a branched polyamide composition. The two branching carbon chains may each have from 4-10 carbon atoms. It has been found that a polyamide composition with short chain (10 or fewer carbons) branching exhibits higher melt viscosity, as well as a relatively high complex viscosity at low shear rates, and a relatively low complex viscosity at high shear rates, in comparison to its unbranched counterpart.

The dimer acid, also called a dimerized fatty acid, is a dicarboxylic acid prepared by dimerizing an unsaturated fatty acid. Additional information about dimer acids can be found in Kirk-Othmer Encyclopedia of Chemical Technology, Volume 2, pp. 1-13. The dimer acid can include Pripol™ 1013 available from Croda International Plc, Edison, N.J., or a C36 dimer acid available from The Chemical Company, Jamestown, R.I., for example.

The polyamide composition can include the residue of the dimer acid in an amount as low as 4 wt. %, 5 wt. %, 6 wt. %, 7 wt. %, 8 wt. %, 9 wt. %, 10 wt. %, 11 wt. %, or 12 wt. %, or as high as 13 wt. %, 14 wt. %, 15 wt. %, 16 wt. %, 17 wt. %, or 18 wt. %, or within any range defined between any two of the foregoing values, such as 4 wt. % to 18 wt. %, 5 wt. % to 17 wt. %, 6 wt. % to 16 wt. %, 7 wt. % to 15 wt. %, 8 wt. % to 14 wt. %, 9 wt. % to 13 wt. %, 10 wt. % to 12 wt. %, 12 wt. % to 14 wt. %, or 10 wt. % to 13 wt. %, for example. All weight percentages recited herein are based on the total weight of the polyamide composition.

The diamine can be a C4-C6 straight or branched diamine, for example. The diamine can include hexamethylenediamine available from Sigma-Aldrich Corp, St. Louis, Mo., for example.

The polyamide composition can include the residue of the diamine in an amount as low as 0.5 wt. %, 0.6 wt. %, 0.8 wt. %, 1 wt. %, 1.2 wt. %, 1.5 wt. %, 2 wt. %, 2.5 wt. %, or 3 wt. %, or as high as 3.5 wt. %, 4 wt. %, 5 wt. %, 6 wt. %, 8 wt. %, 10 wt. %, 15 wt. % or 20 wt. %, or within any range defined between any two of the foregoing values, such as 0.5 wt. % to 20 wt. %, 0.6 wt. % to 15 wt. %, 0.8 wt. % to 10 wt. %, 1 wt. % to 8 wt. %, 1.2 wt. % to 6 wt. %, 1.5 wt. % to 5 wt. %, 2 wt. % to 4 wt. %, 2.5 wt. % to 3.5 wt. %, 1 wt. % to 3 wt. %, 2 wt. % to 6 wt. %, or 4 wt. % to 10 wt. %, for example.

The salt of 5-sulfoisophthalic acid can be lithium 5-sulfoisophthalate, sodium 5-sulfoisophthalate, potassium 5-sulfoisophthalate, or a combination thereof. The lithium 5-sulfoisophthalate is shown below:

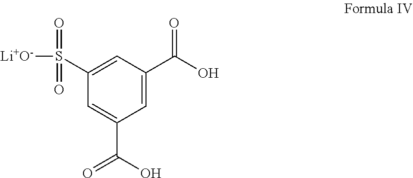

The sodium 5-sulfoisophthalate is shown below:

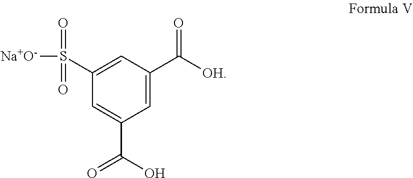

The potassium 5-sulfoisophthalate is shown below:

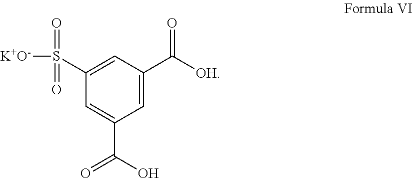

The polyamide composition can include the residue of the 5-sulfoisophthalic acid salt or 5-sulfoisophthalic acid in an amount as low as 0.1 weight percent (wt. %), 0.5 wt. %, 1 wt. %, 1.5 wt. %, 2 wt. %, 2.5 wt. %, 3 wt. %, 4 wt. % or 5 wt. %, or as high as 6 wt. %, 7 wt. %, 8 wt. %, 9 wt. %, 10 wt. %, 12 wt. % or 15 wt. %, or within any range defined between any two of the foregoing values, such as 0.1 wt. % to 15 wt. %, 0.5 wt. % to 12 wt. %, 1 wt. % to 10 wt. %, 1.5 wt. % to 9 wt. %, 2 wt. % to 8 wt. %, 2.5 wt. % to 7 wt. %, 3 wt. % to 6 wt. %, 4 wt. % to 5 wt. %, 0.5 wt. % to 5 wt. %, 6 wt. % to 15 wt. %, 8 wt. % to 12 wt. %, or 0.5 wt. % to 1.5 wt. %, for example.

The polyamide composition has been shown to display excellent stain resistance characteristics. As noted above, many common stains, such as coffee, wine, and food coloring, are acidic in nature. These materials may stain nylon (polyamide) fibers by binding to the terminal basic amine groups in the nylon polymers. Negatively charged groups in the polymers may help repel acidic materials, rendering the fibers stain resistant. Without being bound by theory, it is believed that the residue of the 5-sulfoisophthalic acid salt or 5-sulfoisophthalic acid increases stain resistance by increasing the negative charge on of the polymer composition.

One measurement of stain resistance is the total color difference ΔE. ΔE is a measurement of change in visual perception of a stained sample compared to a standard color sample, per CIE DE2000. A ΔE value of 0 means there is no measurable difference between the stained sample and the standard color sample. A ΔE value of around 2 is generally considered to be the smallest color difference perceptible by the human eye.

The ΔE of the polyamide composition may be less than 10, less than 9, less than 8, less than 7, less than 6, less than 5, less than 4, less than 3 or less than 2, or less than any value within any range defined between any two of the foregoing values.

The amine end group concentration (AEG) may be determined by the amount of hydrochloric acid (HCl standardized, 0.1N) required to titrate a sample of the polyamide composition in solvent of 70% phenol and 30% methanol according to Equation 1 below:

$$AEG = \frac{( mL HCl to titrate sample - mL HCl to titrate blank ) \times ( Normality HCI ) \times 1000}{sample weight in grams .} \qquad Equation 1$$

The polyamide composition may have a total amine end group concentration as low as about 5 millimoles per kilogram (mmol/kg), about 10 mmol/kg, about 15 mmol/kg, about 20 mmol/kg or about 25 mmol/kg, or as high as about 30 mmol/kg, about 35 mmol/kg, about 40 mmol/kg, about 45 mmol/kg or about 50 mmol/kg, or within any range defined between any two of the foregoing values, such as about 5 mmol/kg to about 50 mmol/kg, about 10 mmol/kg to about 45 mmol/kg, about 15 mmol/kg to about 40 mmol/kg, about 20 mmol/kg to about 35 mmol/kg, about 25 mmol/kg to about 30 mmol/kg, about 10 mmol/kg to about 35 mmol/kg, about 10 mmol/kg to about 20 mmol/kg or about 30 mmol/kg to about 40 mmol/kg, for example.

The polyamide composition may have a relative viscosity (RV) as low as about 2.0 RV, about 2.5 RV, about 3.0 RV, about 3.5 RV, about 4.0 RV, about 4.5 RV, or as high as about 5.0 RV, about 5.5 RV, about 6.0 RV, about 6.5 RV, about 7.0 RV, or within any range defined between any two of the foregoing values, such as about 2.0 RV to about 7.0 RV, about 2.5 RV to about 6.5 RV, about 3.0 RV to about 6.0 RV, about 3.5 RV to about 5.5 RV, about 4.0 RV to about 5.0 RV, about 4.5 RV to about 5.0 RV, about 2.0 RV to about 4.5 RV or about 5.0 RV to about 7.0 RV, for example. All relative viscosity measurements herein are as measured by GB/T 12006.1-2009/ISO 307:2007.

The polyamide composition may have a formic acid viscosity (FAV) as low as about 200 FAV, about 250 FAV, about 300 FAV, about 350 FAV, about 400 FAV, about 450 FAV, about 500 or as high as about 550 FAV, about 600 FAV, about 650 FAV, about 700 FAV, about 750 FAV, about 800 FAV, about 850 FAV, about 900 FAV, or about 950 FAV, or within any range defined between any two of the foregoing values, such as about 200 FAV to about 950 FAV, about 250 FAV to about 900 FAV, about 300 FAV to about 850 FAV, about 350 FAV to about 800 FAV, about 400 FAV to about 750 FAV, about 450 FAV to about 700 FAV, about 500 FAV to about 650 FAV, about 550 FAV to about 600 FAV, about 350 FAV to about 550 FAV, about 300 FAV to about 600 FAV or about 400 FAV to about 500 FAV, for example. All FAV measurements herein are as measured by ASTM D-789-07.

The polyamide composition may have a low moisture level as measured by ASTM D-6869. The moisture level may be less than about 1,500 ppm about 1,200 ppm, about 1,000 ppm, about 800 ppm, about 600 ppm, about 500 ppm, or about 400 ppm, or less than a moisture content within any range defined between any two of the foregoing values.

The stain resistant, branched, polyamide composition can be synthesized by providing caprolactam, a dimer acid, a diamine and a 5-sulfoisophthalic acid salt or 5-sulfoisophthalic acid and water to a reactor, mixing the caprolactam, the dimer acid, the diamine and the 5-sulfoisophthalic acid salt or 5-sulfoisophthalic acid together in the reactor, and reacting the caprolactam, the dimer acid, the diamine and the 5-sulfoisophthalic acid salt or 5-sulfoisophthalic acid within the reactor at a reaction temperature. The diamine may be provided in an aqueous solution. The water may be added to the reactor prior to reacting the caprolactam, the dimer acid, the diamine and the 5-sulfoisophthalic acid salt or 5-sulfoisophthalic acid within the reactor. The reactor may be under a reaction pressure during at least a portion of the reacting step. A vacuum may be applied to the reactor to remove water generated during the reacting step. The mixing may continue during at least a portion of the reacting step.

The reaction temperature may be as low as about 225° C., about 230° C., about 235° C., or as high as about 260° C., about 270° C., about 280° C., about 290° C., or within any range defined between any two of the foregoing values, such as about 225° C. to about 290° C., about 230° C. to about 280° C., about 235° C. to about 270° C., about 230° C. to about 260° C., about 260° C. to about 280° C., or about 260° C. to about 270° C. for example.

In the providing step, a condensation catalyst may be provided. Suitable condensation catalysts include hypophosphorous acid salt or sodium hypophosphite, for example. The condensation catalyst may be provided at a concentration as low as about 50 ppm, about 100 ppm or about 150 ppm, or as high as about 200 ppm, about 250 ppm, or about 300 ppm, or within any range defined between any two of the foregoing values, such as about 50 ppm to about 300 ppm, 100 ppm to about 250 ppm, 150 ppm to about 200 ppm, about 50 ppm to about 150 ppm, or about 150 ppm to about 250 ppm, for example.

The FIGURE is a schematic diagram showing a system and process 120 for forming fibers or filaments from the polyamide compositions disclosed herein. As illustratively shown in the FIGURE, the polyamide composition is provided as a feed 122 to the hopper of an extruder 124, then melted in the extruder and pumped out through the spinneret 126 as fibers 128. The heated, polyamide composition is spun using a spinneret 126, which may include one or more outlets for forming individual fibers 128 with a round or delta cross section. The individual fibers 128 may then be collected at 132 and drawn over one or more drawing rollers 134 before the resulting fibers 136 are collected in a wind-up bobbin 138 (as textiles and carpet fibers). Each fiber 136 may contain as few as 30, 32, 34, or as many as 56, 58, 60, filaments, or within any range defined between any two of the foregoing values, such as 30 to 60, 32 to 58, or 34 to 56 filaments, for example.

Polyamide compositions made by the methods described above may be extruded and spun to form partially oriented yarn (POY) and fully drawn yarn (FDY) fibers at moderate take up speeds and increasing draw ratios, which allows for higher strength fiber manufacturing.

The fibers may be formed at take up speeds as low as 200 meters per minute (m/min), 300 m/min, 400 m/min or 500 m/min, or as high as 1,200 m/min, 1,400 m/min, 1,600 m/min, 1,800 m/min, or 2,000 m/min, or within any range defined between any two of the foregoing values, such as 200 m/min to 2,000 m/min, 300 m/min to 1,800 m/min, 400 m/min to 1,600 m/min, 500 m/min to 1,400 m/min, 1,600 m/min to 2,000 m/min, 600 m/min to 1,200 m/min, or 1,200 m/min to 2,000 m/min, for example.

The fibers may have a tenacity as low as 3.0 grams per denier (gpd), 3.2 gpd, 3.4 gpd, 3.6 gpd, 3.8 gpd, 4.0 gpd, 4.2 gpd, 4.4 gpd, 4.6 gpd, 4.8 gpd or 5.0 gpd, or as high as 5.2 gpd, 5.4 gpd, 5.6 gpd, 5.8 gpd, 6.0 gpd, 6.2 gpd, 6.4 gpd, 6.6 gpd, 6.8 gpd or 7.0 gpd, or within any range defined between any two of the foregoing values, such as 3.0 gpd to 7.0 gpd, 3.2 gpd to 6.8 gpd, 3.4 gpd to 6.6 gpd, 3.6 gpd to 6.4 gpd, 3.8 gpd to 6.2 gpd, 4.0 gpd to 6.0 gpd, 4.2 gpd to 5.8 gpd, 4.4 gpd to 5.6 gpd, 4.6 gpd to 5.4 gpd, 4.8 gpd to 5.2 gpd, 4.8 gpd to 7.0 gpd or 5.0 gpd to 6.0 gpd, for example.

While this invention has been described as relative to exemplary designs, the present invention may be further modified within the spirit and scope of this disclosure. Further, this application is intended to cover such departures from the present disclosure as come within known or customary practice in the art to which this invention pertains.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### EXAMPLES

### Example 1—Preparation of a Branched Polyamide Composition Including a Residue of a 5-sulfoisophthalic Acid Salt (Branched SIPA Polyamide)

In this Example, the preparation of a branched polyamide composition including a reside of a 5-sulfoisophthalic acid salt (SIPA) is demonstrated. A reactor was prepared by fitting a 12 L stainless-steel vessel with a helical agitator. The reactants provided to the reactor included 4,760 grams caprolactam (AdvanSix Resins and Chemicals LLC, Parsippany, N.J.), 672 grams Pripol™ 1013 dimer acid (Croda Incorporated, Wilmington Del.), 39.8 grams of sodium 5-sulfoisophthalate (Sigma-Aldrich Corp., St. Louis, Mo.), and 195 grams of a solution consisting essentially of 70 wt. % hexamethylenediamine and 30 wt. % water (Sigma-Aldrich Corp., St. Louis, Mo.). A condensation catalyst was also provided to the reactor in the form of hypophosphorous acid salt at a concentration of about 100 parts per million, as well as 100 grams of deionized water.

The reactants, the catalyst and the water were mixed together in the reactor. The reactor was heated to a reaction temperature of about 230° C. and the reactants mixed for one hour. A reactor pressure of about 6.5 bars was observed. After the one hour, the reactor was vented to release the pressure. The reaction temperature was maintained at 230° C. and held for one hour while the reactor was swept with nitrogen (2 L/min) and the contents mixed with the helical agitator to allow the polyamide composition to grow in molecular weight. After one hour, the polyamide composition was vacuum distilled and mixed until the helical agitator reached a torque limiting value of about 55 Nm. The polymer composition was extruded from the reactor and into a water trough to cool the polyamide composition. The cooled polyamide composition was pelletized with a pelletizer to form chips of the polyamide composition. The chips were leached three times at 120° C. at a pressure of about 15 psi for one hour in deionized water for a total time of three hours to remove unreacted caprolactam. The rinsed polyamide composition was dried in a vacuum oven at 80° C. and a vacuum of 28 inches of mercury to produce a polyamide composition with a moisture content of about 800 parts per million.

### Example 2—Comparison of Polyamide Compositions With and Without Branching and a Residue of a 5-sulfoisophthalic Acid Salt

In this Example, the performance of the branched SIPA polyamide composition of Example 1 is compared to a double-terminated polyamide polymer DTPP (Aegis® MBM available from AdvanSix Incorporated, Parsippany, N.J.), an unterminated nylon-6 (Aegis® H55ZIE, available from AdvanSix Incorporated), and a commercially available stain resistant polyamide polymer. Multifilament fibers of the branched SIPA polyamide composition of Example 1 were produced by extruding the branched SIPA polyamide composition from a single screw extruder at a rate of 6 to 12 pounds per hour. The extruder had a 2-inch diameter screw and a 27 to 1 length to diameter with mixing. The zone temperatures of the extruder were set between 255° C. and 265° C. for an extruder pressure of about 750 psig (with capillary shear viscosity of between 3,500⁻¹ and 7,000 sec⁻¹). The fibers were spun using spinnerets with 0.4 mm diameter capillaries with cross flow air quenching (40% flow, 24° C., 50% relative humidity) on a stack height of about 10 feet from the exit of the spinnerets to the first driven take up roll.

The multifilament fibers of the branched SIPA polyamide composition of Example 1 were evaluated for spinning processing performance and resulting tensile properties when processed at take up speeds of between 400 mpm and 1,600 mpm to produce a range of POY and FDY samples. The POY/FDY sample fibers produced were 70 to 2,700 denier with 36 individual filaments per fiber.

The fibers of the branched SIPA polyamide composition were evaluated for tenacity and elongation percentage. Fibers made from the DTPP, the nylon-6 and the commercially available stain resistant polyamide polymer were also spun and evaluated for comparison. The results are shown in Table 1 below.

TABLE 1

| | Mechanical | | Tenacity | Elongation |
|---|---|---|---|---|
| Sample | Draw Ratio | Denier | (gpd) | (%) |
| Branched SIPA | 5.5 | 712 | 6.5 | 30 |
| Polyamide | | | | |
| DTPP | 4.6 | 868 | 4.6 | 44 |
| Nylon-6 | 4.5 | 806 | 4.2 | 41 |
| Commercially | 4.0 | 373 | 3.8 | 56 |
| Available Stain | | | | |
| Resistant Polyamide | | | | |

As shown in Table 1, POY/FDY fibers produced from the branched SIPA polyamide composition of Example 1 achieved a mechanical draw ratio and a tenacity as good as, or better than, fibers produced from DTPP or nylon-6, and a tenacity much better than the commercially available stain resistant polyamide.

The branched SIPA polyamide composition and the comparative polyamide polymers were evaluated for stain resistance as indicated by the total color difference ΔE. A solution of 100 mg of FD&C Red 40 dye was dissolved in 200 mL of water, and citric acid added to achieve a pH of about 2.8. Samples were placed in the Red 40 dye solution for 30 seconds, and then rinsed with water. The stained samples were placed in a vacuum oven at 90° C. for 24 hours to dry. Both stained and non-stained original samples were wound onto white cardboard cards and the color measured with a spectrophotometer (Konica Minolta CM-5 Spectrophotometer) to determine L, a and b values on the CIE L,a,b color space. Standard ΔE values were calculated based on the color measurements using Equation 2. Standard ΔE measures color change from staining due to dye uptake.

ΔE=((ΔL²)+(Δa²)+(Δb²))^{0.5} Equation 2:

Standard ΔE measures color change from staining due to dye uptake. Both polymer chips and fibers formed from the polymer chips were measured. The results are shown in Table 2.

TABLE 2

| | | 5-sulfoisophthalic | | |
|---|---|---|---|---|
| | AEG | acid concentration | ΔE | ΔE |
| Sample | (mmol/Kg) | (wt. %) | (chips) | (fiber) |
| Branched SIPA | 13 | 0.8 | 3 | 1 |
| Polyamide | | | | |
| DTPP | 20 | 0 | 31 | 35 |
| Nylon-6 | 55 | 0 | 43 | 26 |
| Commercially | 9 | 1.5 | 4 | 2 |
| Available Stain | | | | |
| Resistant Polyamide | | | | |

The fibers of the branched SIPA polyamide fiber demonstrate surprisingly superior stain resistance, even compared to the commercially available stain resistant polyamide polymer. Thus, unlike any of the comparative polyamide polymers, the branched SIPA polyamide produces fibers with excellent mechanical draw ratio and tenacity, as well as excellent stain resistance.

What is claimed is:

1. A polyamide composition comprising the following formula: 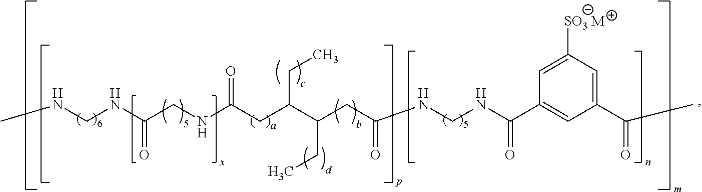
wherein M is a lithium ion, a sodium ion, a potassium ion, or a hydrogen ion;
a=6 to 10;
b=6 to 10;
c=4 to 10;
d=4 to 10;
n=1 to 20;
p=1 to 1000;
m=1 to 400 and
x=4-200.

2. The polyamide composition of claim 1, wherein the polyamide composition includes a residue of a salt of 5-sulfoisophthalic acid.

3. The polyamide composition of claim 2, wherein the salt of 5-sulfoisophthalic acid is selected from the group consisting of sodium 5-sulfoisophthalate, lithium 5-sulfoisophthalate and potassium 5-sulfoisophthalate.

4. The polyamide composition of claim 2, wherein a concentration of the residue of the salt of 5-sulfoisophthalic acid is from 0.1 wt. % to 15 wt. % based on a total weight of the polyamide composition.

5. The polyamide composition of claim 1, wherein the polyamide composition includes a residue of a dimer acid, the dimer acid including two carbon chains each having more than 5 carbons.

6. The polyamide composition of claim 5, wherein a concentration of the residue of dimer acid is from 6 wt. % to 18 wt. % based on a total weight of the polyamide composition.

7. The polyamide composition of claim 1, wherein a total amine end group concentration of the polyamide composition is from about 5 millimoles per kilogram to about 50 millimoles per kilogram.

8. The polyamide composition of claim 1, wherein a relative viscosity (RV) of the polyamide composition is from about 2.0 to about 7.0 RV, as determined by GB/T 12006.1-2009/ISO 307:2007.

9. The polyamide composition of claim 1, wherein a formic acid viscosity of the polyamide composition is from about 200 FAV to about 950 FAV, as measured by ASTM D-789-07.

10. The polyamide composition of claim 1, wherein a color difference ΔE is less than 10, per CIE DE2000.

11. A fiber formed from the polyamide compositions according to claim 1, the fiber having a tenacity from 3.0 to 7.0 grams per denier.

12. The fiber of claim 11 having a tenacity of from 6.0 to 7.0 grams per denier.

13. A method of making a polyamide composition having the formula: 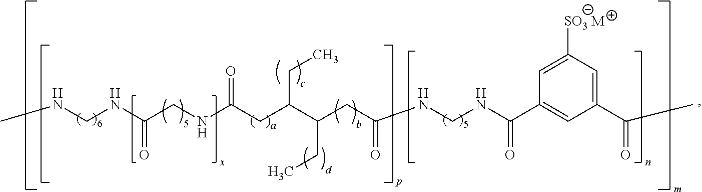
wherein M is a lithium ion, a sodium ion, a potassium ion, or a hydrogen ion, a=6 to 10, b=6 to 10, c=4 to 10, d=4 to10, n=1 to 20, p=1 to 1000, m=1 to 400 and x=4-200, the method comprising:
providing caprolactam, a dimer acid, a diamine and at least one of: a 5-sulfoisophthalic acid salt or 5-sulfoisophthalic acid to a reactor;
mixing the caprolactam, the dimer acid, the diamine and the at least one of: 5-sulfoisophthalic acid salt and 5-sulfoisophthalic acid together in the reactor; and
reacting the caprolactam, the dimer acid, the diamine and the at least one of: 5-sulfoisophthalic acid salt and 5-sulfoisophthalic acid within the reactor at a reaction temperature.

14. The method of claim 13, wherein, in the providing step, the at least one of: 5-sulfoisophthalic acid salt and 5-sulfoisophthalic acid is from 0.1 wt. % to 15 wt. % based on a total weight of the polyamide composition.

15. The method of claim 13, wherein, in the providing step, the at least one of: 5-sulfoisophthalic acid salt and 5-sulfoisophthalic acid is a 5-sulfoisophthalic acid salt selected from the group consisting of: sodium 5-sulfoisophthalate, lithium 5-sulfoisophthalate and potassium 5-sulfoisophthalate.

16. The method of claim 13, wherein, in the providing step, the diamine includes hexamethylenediamine.

17. The method of claim 13, wherein, in the providing step, the dimer acid is from 6 wt. % to 18 wt. % based on a total weight of the polyamide composition.

18. The method of claim 13, wherein, in the reacting step, the reactor is pressurized for a portion of the reacting step.

19. The method of claim 13, wherein, in the reacting step, the reactor is under vacuum for a portion of the reacting step.

20. The method of claim 13, wherein, in the reacting step, the reaction temperature is from about 225° C. to about 290° C.
